(19) United States
(12) Patent Application Publication
(10) Pub. No.: US 2006/0212794 A1
(43) Pub. Date: Sep. 21, 2006

(54) Method and system for creating a computer-readable image file having an annotation embedded therein

(75) Inventors: Christopher A. Evans, Sammamish, WA (US); Craig Adam Beilinson, Bellevue, WA (US); Tomasz S.M. Kasperkiewicz, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/085,664

(22) Filed: Mar. 21, 2005

(51) Int. Cl. G06F 17/00

(52) U.S. Cl. 715/512

(57) ABSTRACT

Methods for creating computer-readable image files having annotation data, e.g., one or more audio annotations, embedded therein are provided. The method may include receiving an image file having image data therein, receiving annotation data, e.g., one or more audio annotations, relating to the image data, and embedding the annotation data into the image file to create a modified image file. Computer-readable media having stored thereon a data structure which includes a first portion containing data representing an image and a second portion containing data representing annotation information relating to the image, wherein the first portion is embedded in the second portion, are also provided. Still further, a computer-readable image file having image data and annotation data relating to the image data is also provided.

### CROSS-REFERENCE TO RELATED APPLICATIONS

Not Applicable.

### STATEMENT REGARDING FEDERALLY SPONSORED RESEARCH OR DEVELOPMENT

Not Applicable.

### TECHNICAL FIELD

The present invention relates to computing environments. More particularly, embodiments of the present invention relate to methods for creating computer-readable image files having annotation data, e.g., one or more audio annotations, embedded therein. Embodiments of the present invention further relate to computer-readable image files embedded with one or more annotations.

### BACKGROUND OF THE INVENTION

Image capture devices, e.g., cameras, exist in the marketplace today which permit a user to record an audio annotation to be associated with a captured image (e.g., a photograph). However, as the image is uploaded or otherwise acquired by a computing system, the image and the associated audio annotation are stored as separate files. Accordingly, when the user attempts to manage the image file, e.g., moving or copying the file to another folder, the audio annotation may become lost. To avoid the loss of any associated audio annotations, a user must either consistently manage an entire folder having both the image file and the file containing the audio annotation therein or make sure the image file and the file containing the audio annotation are otherwise consistently managed. Not only is this a fairly laborious process in that the user must search for and apply the desired treatment to both files, it is also error-prone, particularly as many users, for instance, novice users, may not even know they need to manage more than one file.

Accordingly, a method which permits annotation data, e.g., audio annotations, to persist in association with the image files with which they are associated would be desirable. Additionally, a method which facilitates the creation of a single computer-readable file having both an image and an annotation, e.g., an audio annotation, associated therewith would be advantageous.

### BRIEF SUMMARY OF THE INVENTION

Embodiments of the present invention relate to methods for creating a computer-readable image file having one or more annotations embedded therein. In one embodiment, the method includes receiving an image file having image data therein, receiving annotation data, e.g., one or more audio annotations, relating to the image data, and embedding the annotation data into the image file to create a modified image file. If desired, the method may further include determining if the image file and the annotation data are related to one another prior to embedding the annotation data into the image file.

Additionally, embodiments of the present invention relate to computer-readable media having computer-executable instructions for performing the methods disclosed herein, as well as to computers programmed to perform the disclosed methods.

Embodiments of the present invention further relate to computer-readable media having stored thereon a data structure. In one embodiment, the data structure comprises a first portion containing data representing an image and a second portion containing data representing an annotation, e.g., an audio annotation, relating to the image, wherein the second portion is embedded in the first portion.

Still further, embodiments of the present invention relate to computer-readable image files including image data and one or more annotations relating to the image data.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a flow diagram showing a method for creating a computer-readable image file having annotation data, e.g., one or more audio annotations, embedded therein, in accordance with an embodiment of the present invention; and

FIG. 3 is block diagram of an illustrative data structure having an image portion and an annotation data portion, the annotation data portion being embedded in the image portion, in accordance with an embodiment of the present invention.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of he methods employed, the terms should not be interpreted as implying any particular order among or between various steps herein disclosed unless and except when the order of individual steps is explicitly described.

Embodiments of the present invention provide methods for creating a computer-readable image file having annotation data, e.g., one or more audio annotations, embedded therein. Embodiments of the present invention further provide one or more computer-readable media having stored thereon a data structure including a first portion containing data representing an image and a second portion containing data representing one or more annotations relating to the image, wherein the first portion is embedded in the second portion. Still further, embodiments of the present invention provide a computer-readable image file having image data and one or more annotations relating to the image data.

Having briefly described an overview of the present invention, an exemplary operating environment for the present invention is described below.

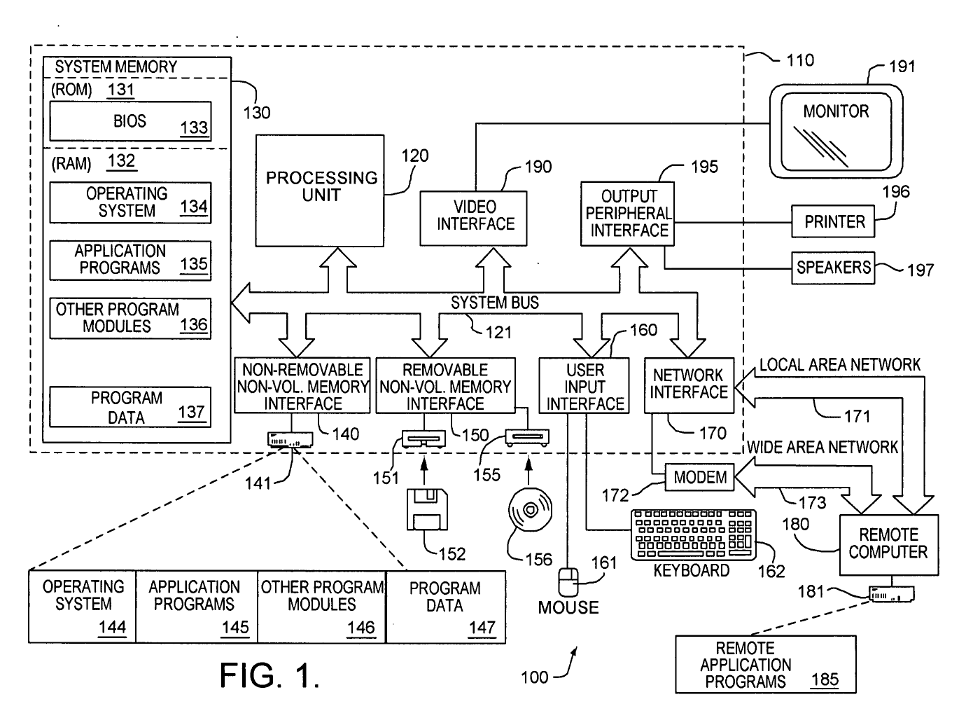

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

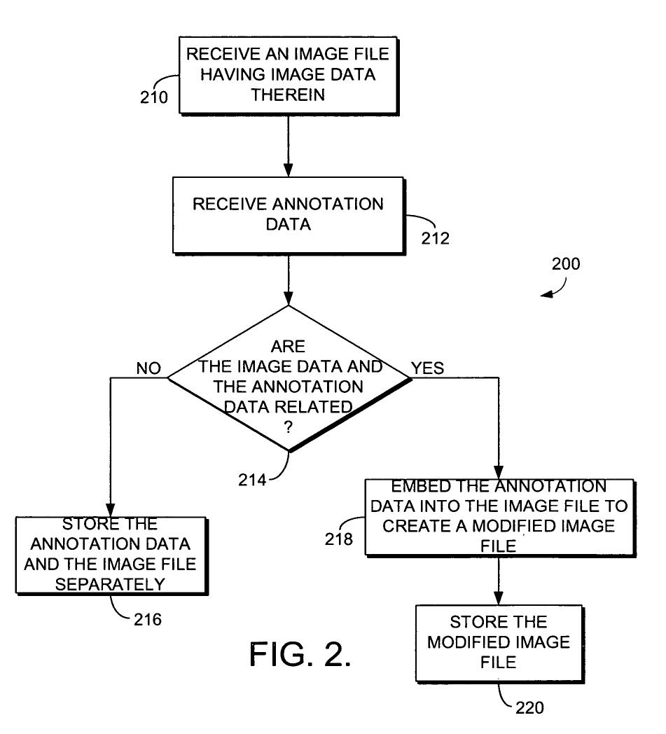

As previously mentioned, embodiments of the present invention relate to methods for creating computer-readable image files having annotation data, e.g., one or more audio annotations, embedded therein. With reference to FIG. 2, a flow diagram is illustrated which shows a method 200 for creating a computer-readable image file in accordance with an embodiment of the present invention. Initially, as indicated at block 210, an image file having image data therein is received. Typically, the received image data will be received as an image file designated by a base file name and an extension indicating an image file type. For instance, the image file may be designated as “image_{—}001 jpg”, “image_{—}001.tiff”, or with a raw file format extension, e.g., “image_{—}001.crw”.

Subsequent to or simultaneously upon receipt of the image data, annotation data, e.g., one or more audio annotations, is received which relates to the image data. This is indicated at block 212. Annotation data describes, indexes, or otherwise pertains to the image data and may include any information a user wishes to associate with the image data that is stored as a separate file from the image data as described herein. One example of annotation data is an audio annotation that is stored as a separate file from the image file and which may be separately selected and/or managed. Accordingly, audio annotations do not include the soundtrack or sound accompaniment to, for instance, a video stream.

Annotation data may be received from one or more files each including at least a portion of the annotation data therein. If the received annotation data relates to a particular image, it will typically be designated by the same base file name as the image file to which it relates but, as it will be in a different file format, e.g., an audio file format, it will include a different extension which indicates, for instance, an audio file type. Thus, by way of example only, an audio file relating to the exemplary image described hereinabove with regard to receipt of the image data may be designated as, by way of example only, “image_{—}001.wav” or “image_{—}001.mp3”.

In one embodiment of the method described herein, a determination of whether the image data and the annotation data are related may be made by the system, as indicated at block 214. This determination may be made by examining the base file name designation given particular image data and comparing it to the base file name of all annotations, that is, all files having a file format extension indicative of a file type other than the image file type. If one or more annotations are located which include an identical base file name and a file format extension indicating an annotation file type, the annotation data contained in those files may be determined to be related to the image data.

It should be noted that in one embodiment the system may be configured to recognize any one of a set of annotation formats, e.g., all known audio formats, as related to image data having an identical base file name. Alternatively, the system may be configured to recognize only a single, predetermined annotation format, e.g., those audio files having a WAV extension, as related to image data having an identical base file name. In the latter scenario, the method may further include transcoding all annotation files received in a format other than the predetermined format (that is, all annotation files having non-ambiguous file format extensions other than a predefined extension) into the predefined file format prior to determine whether the image data and the annotation data are related. Additionally, a file extension may be misleading or ambiguous. In this case, the files may be examined by the codecs to determine the correct format. All such variations, and any combination thereof, are contemplated to be within the scope hereof.

If the image data and the annotation data are determined to be unrelated, that is, if the image file containing the image data and the annotation file containing the annotation data are not designated by the same base file name, the annotation data and the image file may be separately stored, as indicated at block 216. If, however, the image data and the annotation data are determined to be related, the annotation data is subsequently embedded into the image file to create a modified image file. This is indicated at block 218.

One way in which annotation data, in this case audio annotation data, may be embedded into the image file is described hereinbelow. However, it will be understood and appreciated that numerous methods for embedding data are known to those of ordinary skill in the art and any such methods may be utilized in accordance with embodiments of the present invention. The below-described method is provided herein by way of example only and is not intended to limit the scope of the present invention in any way.

Data files are often organized in containers, each container having one or more blocks of data therein. The container itself does not contain any useful information but simply defines how to organize the blocks of data. The container may include an index associated therewith that sets forth information about each of the blocks, for instance, to aid in navigation through the container. Each block within the container typically includes a tag ID (that is, a series of characters that describe and define the data included in the block), a size indicating how large the data included in the block is, and the data itself. For instance, a block for containing a 45 KB image may include a tag ID indicating the image designation (e.g., image_{—}001), an indicator of the size of the image (e.g., the image width and/or height), and the image data.

Containers for image data include, by way of example only, JFIF (a container commonly used for JPG files), EXIF (a container commonly used for JPG files received from a camera), TIFF (the industry standard digital imaging container), or CIFF (a predecessor to TIFF used in CRW and other formats). Each of these containers/file formats supports named segments, the names often being referred to as tags. To embed annotation data into one of the above-described image containers, a tag for one of the blocks contained therein may be created and the raw data stream for the annotation data may be placed in a new segment in the block that is designated by the created tag.

By way of example only, in the case of JFIF/EXIF, the data may be put into a set of APP1 data blocks. The reason a set of blocks may be needed is that each data block is currently limited to a capacity of 64 KB. An exemplary generic manner in which data may be organized into APP1 blocks, two blocks in this example, is as follows:

| WORD | APP1 | OxFFE1 |
|---|---|---|
| WORD | Size | Size of Segment |
| CHAR[3] | Signature | “SOA”, i.e., Start of Annotation |
| CHAR [3] | Type | The type of the data (i.e., the extension |
| | | of the embedded data) |
| WORD | ID | An identifier for this type of data (in |
| | | case there is more than one embedded |
| | | annotation) |
| WORD | NumBlocks | Number of additional blocks for this data |
| <<Data>> | | |

| WORD | APP1 | OxFFE1 |
|---|---|---|
| WORD | Size | Size of Segment |
| CHAR[3] | Signature | COA, i.e., Continuation of Annotation |
| WORD | ID | An identifier for this type of data (in |
| | | case there is more than one embedded |
| | | annotation) |
| WORD | BlockNum | The number of the block (≧1) |
| <<Data>> | | |

In the above example, the first line of the first block indicates an identifier for the data segment contained therein. The second line of the first block indicates the size of the data segment. As other applications may use a like block structure, a signature indicating what is included in the block is included at the third line of the first block. The fourth line of the first block indicates the type of data included in the block, generally identical to the three character extension of the file. The fifth line of the first block indicates an identifier which identifies the type of data (e.g., audio annotation), in case there is more than one embedded annotation. The sixth line of the first block indicates the number of additional blocks that are used to contain the designated data, in case more than one block is necessary. As previously mentioned, each of these blocks currently have a 64 KB capacity. Thus, if the data being embedded into the image file exceeds 64 KB, the sixth line of the first block would indicate how many additional blocks there are that contain the embedded data.

The second block contains only five lines as the line indicating the type of data included in the block is omitted as unnecessary. The first four lines of the second block are similar to the similarly designated lines of the first block. The fifth line, however, indicates which block the present block is in the number of additional blocks designated in the first block.

Thus, by way of example only, contemplate that the above-described embedding format is utilized to embed a 100 KB audio annotation into an image file, the audio annotation being located in a file having the identical base file name as the image file and a WAV extension. In this case, the embedded data would appear as follows:

| WORD | APP1 | OxFFE1 |
|---|---|---|
| WORD | Size | 64 KB (the first 64 KB of the 100 KB |
| | | audio file) |
| CHAR[3] | Signature | SOA |
| CHAR[3] | Type | WAV |
| WORD | ID | Audio Annotation |
| WORD | NumBlocks | 1 |

| | |
|---|---|
| <<Data>> | (the first 64 KB of the 100 KB audio file) |

| WORD | APP1 | OxFFE1 |
|---|---|---|
| WORD | Size | 36 KB (the remaining portion of the 100 KB |
| | | audio file) |
| CHAR[3] | Signature | COA |
| WORD | ID | Audio Annotation |
| WORD | BlockNum | 1 (the first additional data block) |

| | |
|---|---|
| <<Data>> | (the remaining 36 KB of the 100 KB audio file) |

Once embedded as hereinabove described, the image file has become a modified image file—modified by the addition of embedded annotation data. Subsequently, with reference back to FIG. 2, the modified image file is stored by the system as a single file, as indicated at block 220.

The methods herein described may be utilized to embed annotations other than audio annotations into an image file as well. For instance, THM files that are often associated with CRW files and/or TXT files that might contain GPS or other information may be embedded using the methods hereinabove described, if desired.

Embodiments of the present invention further relate to computer-readable media having computer-executable instructions for performing the methods herein described, as well as to computers programmed to perform the described methods.

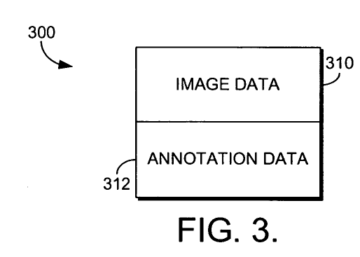

Further, embodiments of the present invention relate to one or more computer-readable media having stored thereon a data structure including a number of portions. With reference to FIG. 3, a schematic diagram illustrating a data structure in accordance with an embodiment of the present invention is illustrated and designated generally as reference numeral 300. The data structure 300 includes a first portion 310 containing data representing an image, e.g., a photograph. The data structure 300 further includes a second portion 312 containing data representing annotation data, e.g., one or more audio annotations, relating to the image. In data structures in accordance with embodiments of the present invention, the second portion 312 is embedded in the first portion 310. In one embodiment, the data structure 300 is a computer-readable file.

Still further, embodiments of the present invention relate to computer-readable image files including image data and annotation data relating to the image data. If desired, the image data may be, for instance, a photograph, and the annotation data may be, e.g., one or more audio annotations.

As can be understood, embodiments of the present invention provide methods for creating a computer-readable image file having annotation data, e.g., one or more audio annotations, embedded therein. Embodiments of the present invention further provide one or more computer-readable media having stored thereon a data structure including a first portion containing data representing an image and a second portion containing data representing annotation information relating to the image, wherein the first portion is embedded in the second portion. Still further, embodiments of the present invention provide a computer-readable image file having image data and annotation data relating to the image data.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for creating a computer-readable image file having annotation data embedded therein, the method comprising:
receiving an image file having image data therein;
receiving annotation data relating to the image data; and
embedding the annotation data into the image file to create a modified image file.

2. The method of claim 1, further comprising determining if the image data and the annotation data are related to one another prior to embedding the annotation data into the image file.

3. The method of claim 1, further comprising storing the modified image file.

4. The method of claim 1, wherein receiving the annotation data relating to the image data comprises receiving one or more audio annotations relating to the image data.

5. The method of claim 1, wherein receiving the annotation data comprises receiving one or more annotation files, each of the one or more annotation files having at least a portion of the annotation data therein.

6. The method of claim 1, wherein receiving an image file having image data therein comprises receiving an image file having data representing a photograph therein.

7. The method of claim 1, wherein receiving an image file comprises receiving an image file having a plurality of blocks associated therewith, and wherein embedding the annotation data into the image file comprises providing one of the plurality of blocks with a predetermined identity and associating the annotation data with the one of the plurality of blocks.

8. One or more computer-readable media having computer-executable instructions for performing the method of claim 1.

9. The method of claim 2, wherein receiving an image file includes receiving an image file having a base file name and a first extension indicating an image file type, and wherein determining if the image data and the annotation data are related to one another comprises determining whether the annotation data includes the base file name and a second extension indicating an annotation file type associated therewith.

10. The method of claim 9, wherein if the annotation data includes the base file name and a second extension indicating an annotation file type associated therewith, the image data and the annotation data are determined to be related to one another.

11. The method of claim 1, further comprising:
determining whether the annotation data is in a predetermined format; and
if the annotation data is not in the predetermined format, transcoding the annotation data into the predetermined format prior to determining if the image data and the annotation data are related to one another.

12. One or more computer-readable media having computer-executable instructions for performing the method of claim 11.

13. A computer programmed to perform the method of claim 1.

14. One or more computer-readable media having stored thereon a data structure, the data structure comprising:
a first portion containing data representing an image; and
a second portion containing data representing annotation information relating to the image, wherein the second portion is embedded in the first portion.

15. The one or more computer-readable media of claim 14, wherein the data structure is a computer-readable file.

16. The one or more computer-readable media of claim 14, wherein the data representing the image contained in the first portion comprises data representing a photograph.

17. The one or more computer-readable media of claim 13, wherein the annotation information contained in the second portion comprises one or more audio annotations.

18. A computer-readable image file, comprising:
image data; and
annotation data relating to the image data.

19. The computer-readable image file of claim 18, wherein the image data comprises data representing a photograph.

20. The computer-readable image file of claim 18, wherein the annotation data comprises one or more audio annotations.
